(19) United States
(12) Patent Application Publication
(10) Pub. No.: US 2009/0245040 A1
(43) Pub. Date: Oct. 1, 2009

(54) OPTICAL DISC REPRODUCING APPARATUS AND OPTICAL DISC REPRODUCING METHOD

(75) Inventor: Shinichiro ARAKAWA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/410,758

(22) Filed: Mar. 25, 2009

(30) Foreign Application Priority Data
Mar. 28, 2008 (JP) 2008-087354

(51) Int. Cl. G11B 7/00; G11B 7/24

(52) U.S. Cl. 369/44.32; 369/275.4; G9B/7

(57) ABSTRACT

An optical disc reproducing apparatus according to the present invention includes an optical pickup for receiving a reflection signal from an optical disc having a land and a groove, an error signal creation unit for creating a tracking error signal from the reflection signal, a polarity switching unit arranged to switch the polarity of the tracking error signal, and a servo processing unit for performing a tracking servo process using the tracking error signal output from the polarity switching unit and creating a drive signal of a tracking actuator provided with the optical pickup, and the polarity switching unit switches the polarity of the tracking error signal in a reproduction state in which the optical disc is reproduced and in a waiting state in which the reproduction is interrupted. According to the optical disc reproducing apparatus, even if a reproduction laser beam is continuously radiated in the waiting state, deterioration of a recording film of a recording type optical disc can be prevented as well as a transition between the waiting state and the reproduction state can be securely performed in a short time.

### CROSS-REFERENCE TO RELATED APPLICATIONS

This application claims the benefit of priority of Japanese Patent Application No. 2008-87354, filed Mar. 28, 2008, the entire contents of which are incorporated herein by reference.

### BACKGROUND

1. Field

The present invention relates to an optical disc reproducing apparatus and an optical disc reproducing method, and, more particularly, to an optical disc reproducing apparatus and an optical disc reproducing method for reproducing a recording type optical disc.

2. Description of the Related Art

It is known that when a laser beam of reproducing power is continuously radiated to a recording type optical disc (for example, CD-R, CD-RW, DVD-R, DVD-RW, and the like), a recording film is gradually deteriorated although it is only in a minute amount. Although a deterioration speed is different depending on characteristics of the recording type optical disc, laser power, a scanning speed of a light spot, and the like, the quality of the disc may be deteriorated to such a degree that recorded data cannot be reproduced by the scanning performed continuously millions of times depending on a condition. Accordingly, when the recording type optical disc is reproduced, it is preferable not to radiate a laser beam onto the optical disc during a period in which the disc is not involved in reproduction.

In general, an optical disc drive (optical disc reproducing apparatus), which is connected to (or built is) a personal computer and the like, reproduces recorded data requested by a reproduction request command from a host apparatus (personal computer and the like) and thereafter waits for arrival of a next reproduction request command. The waiting period is called a waiting state (or idle state). In contrast, a period during which recorded data is actually reproduced is called a reproduction state (or active state).

A maximum allowable time is prescribed to the time during which the waiting state shifts to the reproduction state by an optical disc standard. When the shift time is long, an access time to a track, where requested data for reproduction is recorded, is increased, which affects a reproduction performance. To assure a short access time, conventionally, the same track is continuously scanned repeatedly while radiating a laser beam of reproduction laser power regardless that no recorded data is reproduced actually (that is, even in the waiting state) so that the waiting state can shift to the reproduction state in a short time. The track, which is continuously scanned in the waiting state, is ordinarily the same track as the track having an address to which a reproduction request is output finally or a track in the vicinity of the above track.

As described above, conventionally, since a reproduction laser beam is continuously radiated regardless that no recorded data is reproduced actually, a recording film is progressively deteriorated uselessly.

In contrast, there are some proposals for improving the above state.

For example, JP-A 2004-71110 discloses a technology for preventing deterioration of a recording film by avoiding a reproduction laser beam from being concentrated to one track in such a manner that a tracking servo loop is opened once in a waiting state and further an optical pickup is forcibly moved by applying a sine wave, a triangle wave, and the like to a tracking actuator.

Further, JP-A 08-306053 discloses a technology for preventing deterioration of a recording film by lowering laser power equivalently by intentionally setting a defocused state by applying an offset voltage to a focusing servo loop in a waiting state.

However, since the technology disclosed in JP-A 2004-71110 opens the tracking servo loop in the waiting state and moves the optical pickup by the sine wave, the triangle wave, and the like, when the waiting state shifts to the reproduction state, an access time for accessing a track from which reproduction of recorded data is requested and a servo pull-in time are necessary, and thus a time necessary to return from the waiting state to the reproduction state (reproduction response time) is increased. Further, since the tracking actuator is driven at all times in the waiting state, power consumption is also increased.

Meanwhile, in the technology disclosed in JP-A 08-306053, even if the equivalent laser power is relatively lowered than a correctly focused state by setting the defocus state, it is not always lowered sufficiently to such a degree that deterioration of a recording film can be prevented. Further, when a defocus amount is excessively increased to sufficiently reduce the equivalent laser power, since the quality of a tracking error signal is deteriorated, there is possibility that a tracking servo operation becomes unstable.

### SUMMARY OF THE INVENTION

Accordingly, an object of the present invention, which was made in view of the above circumstances, is to provide an optical disc reproducing apparatus and an optical disc reproducing method which do not increase power consumption and do not make a servo operation unstable, can prevent deterioration of a recording film of a recording type optical disc even if a reproduction laser beam is continuously radiated in a waiting state, and can securely perform a transition between the waiting state a reproduction state in a short time.

To solve the above problems, an optical disc reproducing apparatus according to the present invention has an optical pickup for radiating a laser beam onto a recording surface of an optical disc having a land and a groove and receiving a reflection signal from the recording surface, an error signal creation unit for creating at least a tracking error signal from the reflection signal, a polarity switching unit arranged to switch the polarity of the tracking error signal output from the error signal creation unit, and a servo processing unit for performing at least a tracking servo process using the tracking error signal output from the polarity switching unit and creating a drive signal of a tracking actuator provided with the optical pickup, and the polarity switching unit switches the polarity of the tracking error signal in a reproduction state in which the optical disc is reproduced and in a waiting state in which the reproduction is interrupted as disclosed in a first aspect of the invention.

Further, to solve the above problems, an optical disc reproducing method has the steps of radiating a laser beam onto a recording surface of an optical disc having a land and a groove and receiving a reflection signal from the recording surface, creating at least a tracking error signal from the reflection signal, switching the polarity of the tracking error signal in a reproduction state in which the optical disc is reproduced and in a waiting state in which the reproduction is interrupted, and performing at least a tracking servo process using the tracking error signal the polarity of which is switched and driving a tracking actuator provided with the optical pickup which receives the reflection signal as disclosed in a fifth aspect of the invention.

According to the optical disc reproducing apparatus and the optical disc reproducing method of the present invention, neither power consumption is increased nor a servo operation is made unstable, whereas even if a reproduction laser beam is continuously radiated in the waiting state, deterioration of a recording film of a recording type optical disc can be prevented as well as a transition between the waiting state and the reproduction state can be securely performed in a short time.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an example of an arrangement of an optical disc reproducing apparatus according to an embodiment of the present invention;

FIG. 2 is a view showing an example of a track structure of an optical disc for recording data only to a groove;

FIG. 3 is a status transition view showing an example of a transition relation of an operating state of the optical disc reproducing apparatus;

FIG. 4 is a flowchart showing an example of a transition process in a reproduction state and a waiting state in a conventional optical disc reproducing apparatus;

FIG. 5 is a flowchart showing an example of a transition process in a reproduction state and a waiting state in the optical disc reproducing apparatus according to the embodiment;

FIG. 6 is a view exemplifying the polarity of inclination of a tracking error signal in groove tracking and land tracking;

FIG. 7 is a view explaining a process when the reproduction state shifts to the waiting state in the optical disc reproducing apparatus according to the embodiment; and

FIG. 8 is a view explaining a process when the waiting state returns to the reproduction state in the optical disc reproducing apparatus according to the embodiment.

### DETAILED DESCRIPTION

An embodiment of an optical disc reproducing apparatus and an optical disc reproducing method according to the present invention will be explained referring to the accompanying drawings.

(1) Arrangement and Overall Operation of Optical Disc Reproducing Apparatus

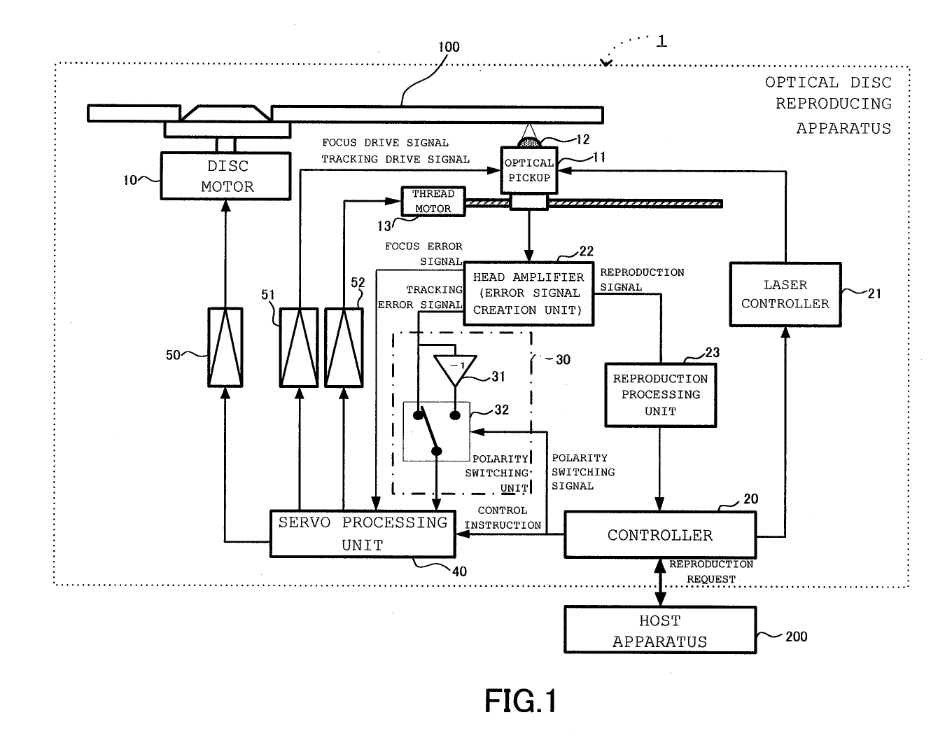

FIG. 1 is a block diagram showing an example of an arrangement of the optical disc reproducing apparatus 1 according to the embodiment. The optical disc reproducing apparatus 1 has a disc motor 10 for rotating an optical disc 100, an optical pickup 11 for radiating a laser beam to the optical disc 100 and reading recorded data from a recording surface of the optical disc 100, and a thread motor 13 for driving the optical pickup 11 in the radial direction of the disc.

The optical pickup 11 has an objective lens 12 disposed thereto, the objective lens 12 being supported by a not shown wire or sheet spring. Further, the optical pickup 11 has a focus actuator and a tracking actuator (any of which is not shown). The objective lens 12 can be moved in a focusing direction (optical axis direction of the lens) by driving the focus actuator and in a tracking direction (radial direction of the optical disc 100) by driving the tracking actuator.

A rotation drive signal is supplied to the disc motor 10 from a servo amplifier 40 through an amplifier 50, and the start and stop of rotation, the rotation speed, and the like of the optical disc 100 are controlled by the rotation drive signal.

Likewise, a movement drive signal is supplied to the thread motor 13 from the servo amplifier 40 through an amplifier 52, and the start and stop of movement, the moving speed, and the like of the optical pickup 11 are controlled by the movement drive signal.

Further, a focus drive signal and a tracking drive signal are supplied to the focus actuator and the tracking actuator of the optical pickup 11 from the servo amplifier 40 through an amplifier 51, respectively.

The position of the objective lens 12 is controlled in a focusing direction by the focus drive signal so that the focus of the laser beam is kept on the recording surface of the optical disc 100 at all times. A head amplifier (error signal creation unit) 22 creates a focus error signal showing the error between the focus of the laser beam and the position of the recording surface based on a signal output from the optical pickup 11. The servo processing unit 10 creates the focus drive signal for driving the objective lens 12 so that the focus error signal is set to zero by a servo control.

On the other hand, the tracking drive signal controls the position of the objective lens 12 in a tracking direction so that the focus of the laser beam is kept on a recording track of the optical disc 100 at all times in reproduction. The head amplifier (the error signal creation unit) 22 creates a tracking error signal showing the error between the center of the laser beam in a radial direction and the center of the recording track based on a signal output from the optical pickup 11. The servo processing unit 40 creates the tracking drive signal for driving the objective lens 12 so that the tracking error signal is set to zero by the servo control.

The optical disc reproducing apparatus 1 according to the embodiment has a polarity switching unit 30 which can switch the polarity of the tracking error signal, and the tracking error signal whose polarity is switched by a polarity switching signal output from a controller 20 is input to the servo processing unit 40. An operation and a working effect of the polarity switching unit 30will be described later.

Although a specific method of switching the polarity of the tracking error signal is not particularly limited, the polarity of the tracking error signal can be switched using, for example, an inverse amplifier 31 for inverting the polarity of the tracking error signal and a switch 32 for switching an inverted tracking error signal and a not-inverted tracking error signal and outputting a switched tracking error signal.

A reproduction signal is also output from the head amplifier 22 in response to the reflection intensity of recorded data, and the reproduction signal is input to a reproduction processing unit 23. The reproduction processing unit 23 demodulates binarized reproduction data from the reproduction signal and outputs it to the controller 20. The controller 20 performs a process such as an error correction to the reproduction data and outputs the reproduction data to a host apparatus 200 such as a personal computer through a not shown interface unit.

The controller 20 also controls the overall optical disc reproducing apparatus 1, and the overall control includes a control as to the transition of the operating state of the optical disc reproducing apparatus 1.

A laser controller 21 controls the power and the turning on/off of a laser element built in the optical pickup 11 based on an instruction from the controller 20.

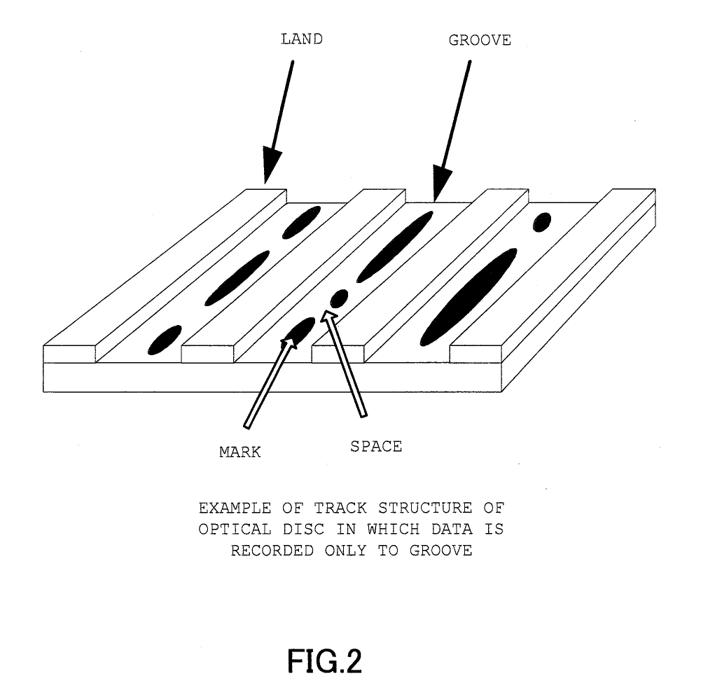

FIG. 2 is a view schematically showing a track structure of the optical disc 100. A track of the recording type optical disc 100 has a guide groove formed thereto as shown in FIG. 2 so that the track can be scanned even in a state that no data in recorded. In general, a track to which a groove is engraved is called a groove, and a track above the groove is called a land. To which of the groove and the land data is recorded is prescribed by an optical disc standard.

Many of recording type optical discs, for example, CD-R, CD-RW, DVD-R, DVD-RW, DVD-R, and DVD+RW are prescribed as groove recording type optical discs (optical discs for recording data only to a groove). FIG. 2 exemplifies a structure of these groove recording type optical discs and shows that data shown by a mark and a space is recorded to a groove.

There may be an optical disc of a type in which data is recorded only to a land on the contrary.

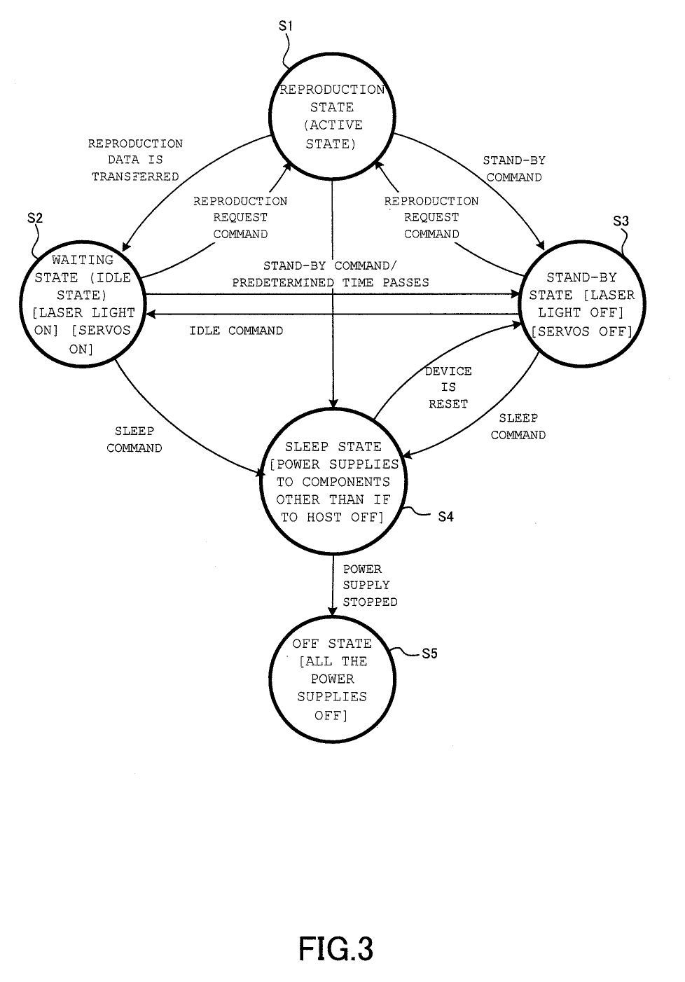

FIG. 3 is a status transition view showing a transition status of an operating state of the optical disc reproducing apparatus 1. Although FIG. 3 is a view showing an ordinary status transition performed conventionally, the optical disc reproducing apparatus 1 according to the embodiment also performs the same status transition as that shown in FIG. 3 basically.

A reproduction state (also called an active state) S1 is a state that the optical disc 100 is actually reproduced, and a waiting state (also called an idle state) S2 is a state that reproduction is temporarily interrupted.

When the optical disc reproducing apparatus 1 receives a reproduction request command from the host apparatus 200 in the waiting state S2, the waiting state S2 shifts to the reproduction state S1 and the optical disc reproducing apparatus 1 reproduces requested data. When the optical disc reproducing apparatus 1 reproduces the requested data and transfers it to the host apparatus, the reproduction state S1 shifts to the waiting state S2. In the waiting state S2, the reproduction laser beam is maintained turned-on so that the waiting state S2 can instantly shift to the reproduction state S1 when a reproduction request command is output from the host apparatus 200, and further the servos (tracking servo and focus servo) are also maintained in a closed state.

When the waiting state S2 continues for a predetermined time or when a stand-by command is output from the host apparatus 200, the waiting state S2 shifts to a stand-by state S3. The stand-by state S3 is a state that both the laser beam and the servos are turned off and thus a certain degree of power can be saved. When an idle command is received in the stand-by state S3, the stand-by state S3 returns to the waiting state S2.

When the stand-by command is received in the reproduction state S1, the reproduction state S1 directly shifts to the stand-by state S3. Further, when the reproduction request command is received in the stand-by state S3, the stand-by state S3 can also directly shift to the reproduction state S1. In this case, since the optical pickup is moved to a desired position and then a process for pulling in the servos and the like is performed, a shift time is more increased than the case that the waiting state S2 shifts to the reproduction state S1.

When a sleep command is received from the host apparatus 200 in the reproduction state S1, the waiting state S2, and the stand-by state S3, any of the states shifts to a sleep state S4. The sleep state S4 is a state in which the power supplies of the components other than the interface unit to the host apparatus 200 are turned off and thus is a state having the highest power saving effect. An off state S5 is a state in which all the power supplies of the optical disc reproducing apparatus 1 including the power supply of the interface are turned off.

The optical disc reproducing apparatus 1 according to the embodiment has a feature in a mutual transition process between the reproduction state S1 and the waiting state S2. The transition process between these two states will be explained below.

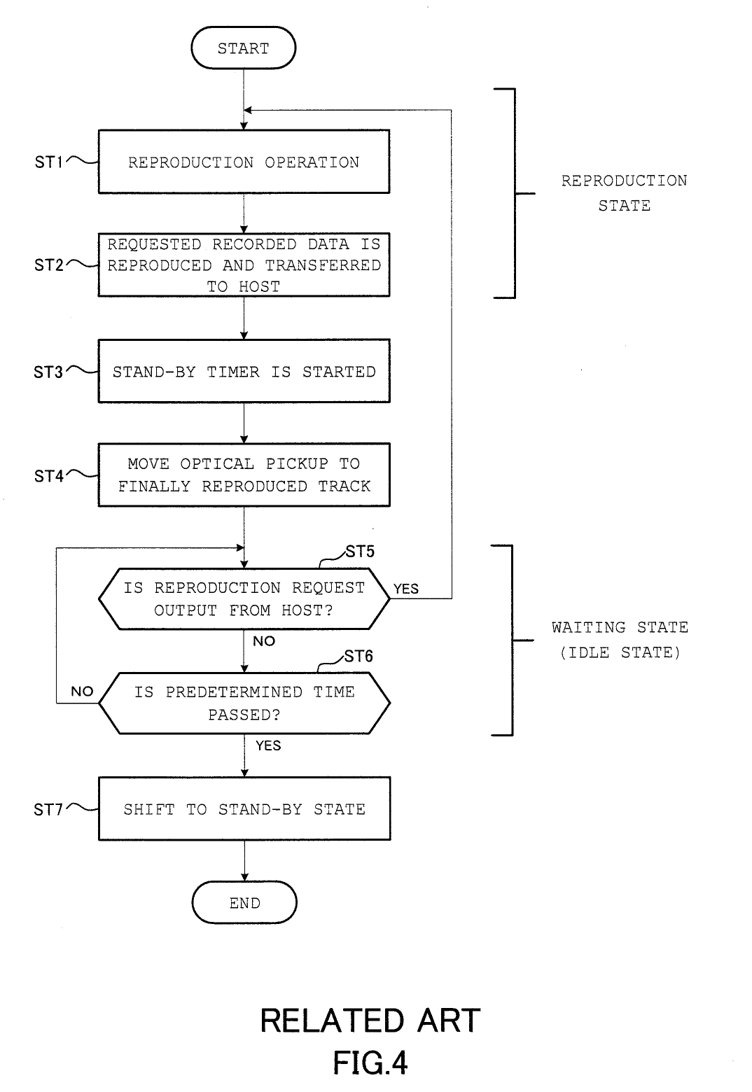

FIG. 4 is a flowchart showing an example of a transition process conventionally performed between the reproduction state S1 and the waiting state S2. In FIG. 4, processes at steps ST1 and ST2 correspond to a process in the reproduction state S1, and processes at steps ST5 and step ST6 correspond to a process in the waiting state S2.

The following description will be made as to a groove recording type optical disc which shows many of currently used recording type optical discs.

First, in a reproduction operation at step ST1, a tracking servo process is performed so that the center of the laser beam agrees with the center of a groove to which data is recorded, and the data recorded to the groove is reproduced. When the recorded data requested from the host apparatus 200 is reproduced and transferred to the host apparatus 200, a transition process from the reproduction state S1 to the waiting state S2 is performed.

Before shifting to the waiting state S2, a stand-by timer, which is used for shifting to the stand-by state S3 (step ST3), is started and then the optical pickup 11 is moved to a finally reproduce track, that is, to a finally reproduced groove or a groove in the vicinity of the above groove. After that, the state shifts to the waiting state S2 (step ST4).

In the waiting state S2, the laser beam is kept turned on at all times as described above so that the waiting state S2 can return to the reproduction state S1 in a short time, and the servo loop is also continuously placed in the turned-on state at all times. In the conventional waiting state S2, it is continuously waited that a next reproduction request command is output from the host apparatus 200 while radiating the laser beam to the groove to which data is recorded at all times.

When the reproduction request command is output from the host apparatus 200 in this state, the waiting state S2 returns to the reproduction state S1 at step ST1, and the requested data is reproduced and transferred. On the completion of the process, the reproduction state S1 shifts to the waiting state S2 again, the optical pickup 11 is moved to a finally reproduced groove or a groove in the vicinity of the above groove, and the process for waiting that a next reproduction request command is output from the host apparatus 200 while radiating the laser beam to the groove at all times is repeated.

When the waiting state S2 is determined to be continued for a predetermined time or longer by the stand-by timer, the waiting state S2 shifts to the stand-by state S3.

As described above, in the conventional method, the laser beam is radiated onto the groove in which data is recorded at all times during the time in which the optical disc reproducing apparatus 1 is placed in the waiting state S2. Accordingly, since the reproduction laser beam is continuously radiated regardless that no data is actually reproduced, the recording film on the groove is progressively deteriorated uselessly.

In contrast, in the embodiment, when a shift is made to the waiting state S2, the laser beam is controlled such that it moves from a track (groove) to which data is recorded to a track (land) to which no data is recorded and the center of the laser beam tracks the land. As a result, in the waiting state S2, the laser beam is radiated onto the land to which no data is recorded, thereby deterioration of the recording film can be prevented.

When the waiting state S2 returns to the reproduction state S1, the laser beam is controlled such that the center thereof moves from the land tracks the center of the groove to which the data is recorded.

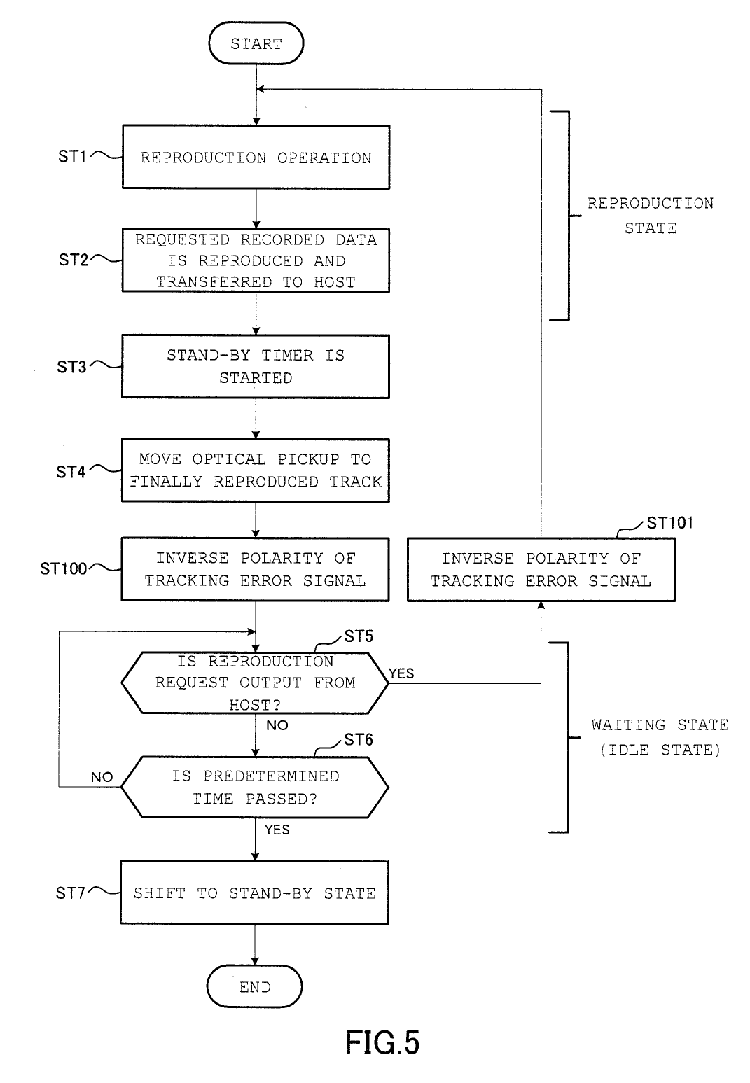

FIG. 5 is a flowchart showing an example of a mutual status transition process between the reproduction state S1 and the waiting state S2 in the optical disc reproducing apparatus 1 according to the embodiment. The status transition process is different from the conventional process (FIG. 4) in that the processes at steps ST100 and ST101 are added.

At step ST100 where the reproduction state S1 shifts to the waiting state S2, a process for switching the polarity of the tracking error signal is performed (the polarity is inverted). Tracking on the groove can be switched to tracking on the land by the switching process.

In contrast, at step ST101 where the waiting state S2 returns to the reproduction state S1, a process for switching the polarity of the tracking error signal again is performed (the polarity is inverted and returned to an original polarity). The tracking on the land can be returned to the tracking on the groove to which the data is recorded by the switching process.

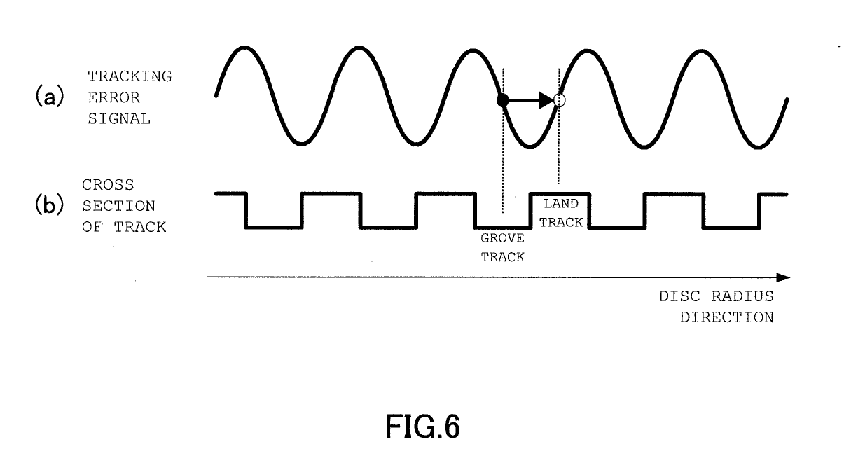

Parts (a) and (b) of FIG. 6 are views exemplifying how groove tracks and land tracks are disposed when they are observed from a radial direction of a disc (part (b) of FIG. 6) and how a tracking error signal (error signal in an open loop) changes in correspondence to the groove tracks and the land tracks (part (a) of FIG. 6).

As apparent from the parts (a) and (b) of FIG. 6, the inclination of the tracking error around the black circle, which shows the inclination of the tracking error signal at the center of the groove track, is just opposite to the inclination of the tracking error signal around the white circle, which shows the inclination of the tracking error signal at the center of the land track. The inclination of the tracking error signal can be inverted between a positive inclination and a negative inclination by switching the polarity of the tracking error signal. This means that tracking to the groove and tracking to the land can be mutually switched by switching the polarity of the tracking error signal.

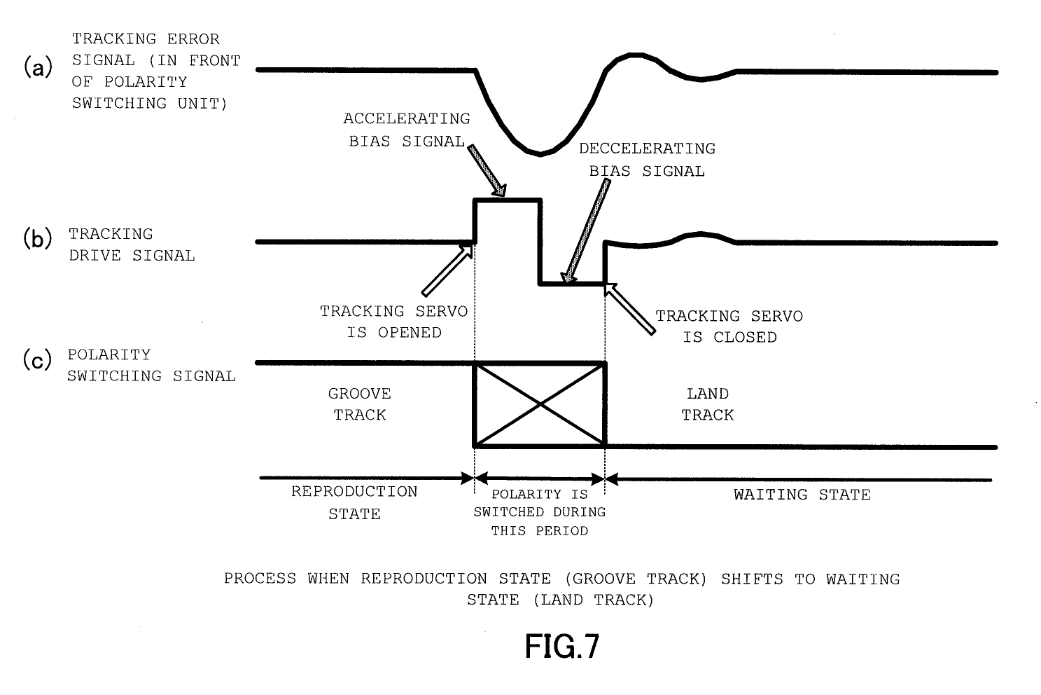

Parts (a), (b) and (c) of FIG. 7 are views explaining processes for shifting groove tracking in the reproduction state S1 to land tracking in the waiting state S2 in more detail.

The part (a) of FIG. 7 shows the tracking error signal (input to the polarity switching unit 30) output from the head amplifier 22. The part (b) of FIG. 7 shows the tracking drive signal output from the servo processing unit 40. Further, the part (c) of FIG. 7 shows the polarity switching signal output from the controller 20 to the polarity switching unit 30.

In the reproduction state S1, the polarity switching signal sets the polarity of the tracking error signal so that the groove to which the data is recorded is tracked (for example, the switch 32 is set such that the tracking error signal output from head amplifier 22 is input to the servo processing unit 40 without being inverted). In the reproduction state S1, the tracking servo loop operates in the closed state, the tracking error signal (part (a) of FIG. 7) is set to approximately in the vicinity of zero, and the tracking drive signal (part (b) of FIG. 7) is also set in the vicinity of zero which is approximately the same value as that of the tracking error signal output from the head amplifier 22.

When the reproduction state S1 is shifted to the waiting state S2, first, the tracking servo loop is opened once. Then, an accelerating bias signal having a predetermined polarity (for example, a positive polarity) and a predetermined level is applied to the tracking actuator as the tracking drive signal.

As a result, the center position of the laser beam is separated from the center position of the groove track, which is finally reproduced in the reproduction state S1, and begins to move in the radial direction of the optical disc. A moving direction and a moving speed are determined by the polarity and the level of the accelerating bias signal.

After the accelerating bias signal is applied for a predetermined period, a deccelerating bias signal having a polarity opposite to that the accelerating bias signal is applied to the tracking actuator. The moving speed of the laser beam in the radial direction is gradually reduced by the decelerating bias signal and approaches zero. At this time, the tracking servo loop is switched from the open state to the closed state, and the waiting state S2 is entered.

Meanwhile, after the tracking servo loop is opened, the polarity of the tracking error signal is switched during the period before the tracking servo loop is closed again.

When the tracking loop is closed again, since the polarity of the tracking error signal is already switched, the center of the laser beam tracks the center of the land in the waiting state S2.

Since after the tracking loop is opened once, it can be sufficiently closed again in a time of about several milliseconds even if a time until the tracking loop is stabilized is included therein (that is, a shift time during which the reproduction state S1 shifts to the waiting state S2), the status transition can be performed in a short time.

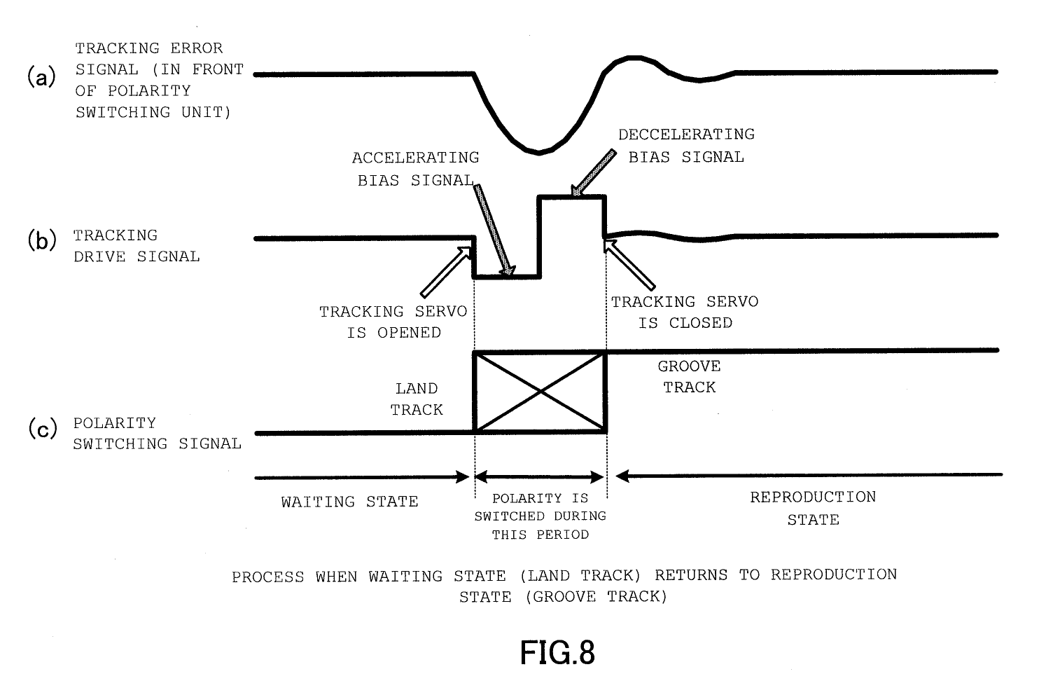

FIG. 8 is a view showing a process when the waiting state S2 is returned to the reproduction state S1 on the contrary. Also in this case, the tracking servo loop is opened once, and the accelerating bias signal and the decelerating bias signal are applied to the tracking actuator during the open period. Further, during the open period, the polarity of tracking error signal is switched so that the polarity thereof for tracking the center of the land is returned to the polarity thereof for tracking the center of the groove.

The process when the waiting state S2 is returned to the reproduction state S1 is different from the process when the reproduction state S1 is returned to the waiting state S2 (FIG. 7) in that the polarities of the accelerating bias signal and the decelerating bias signal, which are applied during the open period, are inverted, respectively, and the absolute values and the application times of the respective bias signals are set approximately similarly. As a result, when the reproduction state S1 shifts to the waiting state S2 and the waiting state S2 returns to the reproduction state S1 again, it is possible to return the center of the laser beam to the position of the groove that is reproduced finally in the previous reproduction state S1. The waiting state S2 can sufficiently return to the reproduction state S1 in about several milliseconds likewise when the reproduction state S1 shifts to the waiting state S2.

Note that it is considered that when the waiting state S2 returns to the reproduction state S1, the address of the reproduction data instructed from the host apparatus 200 is greatly different from that in the previous reproduction state S1. However, in this case, it is sufficient to set the magnitudes and the polarities of the accelerating bias signal and the decelerating bias signal so that they correspond to the instructed address.

Incidentally, even if the polarity of the tracking error signal is switched while closing the tracking loop, since the center position of the laser beam can be switched from the groove to the land, deterioration of the recording film can be prevented in the waiting state S2.

However, in this case, there is a possibility that the moving direction and the moving amount from the position of the finally reproduced groove are not fixed. To cope with this problem, in the embodiment, the position of the land, which is tracked in the waiting state S2, is fixed by opening the tracking loop once and applying the controllable accelerating bias signal and decelerating bias signal as described above.

Ordinarily, when the waiting state S2 returns to the reproduction state S1, the laser beam returns to the same groove as the groove finally reproduced in the previous reproduction state S1 or to a groove adjacent to the above groove and reproduces it in many cases. In this case, the position of the land to be tracked in the waiting state S2 is preferably a land adjacent to the finally reproduced groove or a land in the vicinity of the above land. In the embodiment, the position of the land when the reproduction state S1 shifts to the waiting state S2 can be controllably fixed. Likewise, when the waiting state S2 shifts to the reproduction state S1, the position of the groove, which is tracked in the reproduction state S1, can be fixed.

Accordingly, the mutual transition between the reproduction state S1 and the waiting state S2 can be promptly and securely performed.

Although the above invention uses the groove recording type optical disc in which data is recorded only to the groove as an example, the same processes can be also applied to a land recording type optical disc in which data is recorded only to the land, and the same advantage can be obtained.

As described above, the optical disc reproducing apparatus 1 and the optical disc reproducing method according to the embodiment, neither power consumption is increased nor a servo operation is made unstable, whereas even if a reproduction laser beam is continuously radiated in the waiting state, deterioration of a recording film of a recording type optical disc can be prevented as well as a transition between the waiting state and the reproduction state can be securely performed in a short time.

Note that the present invention is not limited to the above embodiment and can be specifically realized by variously modifying the components thereof when the invention is embodied. Further, various inventions can be created by appropriately combining the plurality of components disclosed in the embodiment. For example, several components may be removed from all the components shown in the embodiment. Further, the components of different embodiments may be appropriately combined.

What is claimed is:

1. An optical disc reproducing apparatus comprising:
an optical pickup configured to radiate a laser beam onto a recording surface of an optical disc comprising a land and a groove and to receive a reflection signal from the recording surface;
an error signal generator configured to generate a tracking error signal from the reflection signal;
a polarity switch configured to switch the polarity of the tracking error signal output from the error signal generator; and
a servo controller configured to execute at least a tracking servo controlling using the tracking error signal output from the polarity switch and to generate a driving signal of a tracking actuator with the optical pickup,
wherein the polarity switch is configured to switch the polarity of the tracking error signal in a reproduction state where the optical disc is reproduced and in a waiting state where the reproduction is interrupted.

2. The optical disc reproducing apparatus of claim 1, wherein:
the polarity switch is configured to set the polarity of the tracking error signal to a polarity by which the optical pickup is configured to follow a groove track in the reproduction state, and to switch the polarity of the tracking error signal to a polarity by which the optical pickup is configured to follow a land track in the waiting state for an optical disc comprising recorded data only on the groove track; and
the polarity switch is configured to set the polarity of the tracking error signal to a polarity by which the optical pickup is configured to follow a land track in the reproduction state, and to switch the polarity of the tracking error signal to a polarity by which the optical pickup is configured to follow the groove track in the waiting state for an optical disc comprising recorded data only on the land track.

3. The optical disc reproducing apparatus of claim 1, wherein the servo controller is configured to open a tracking servo loop once before the polarity of the tracking error signal is switched, and to close the tracking servo loop after the polarity of the tracking error signal is switched.

4. The optical disc reproducing apparatus of claim 3, wherein:
the servo controller is configured to apply a first accelerating bias signal to the tracking actuator within a predetermined range from a current track in a predetermined direction in order to accelerate the tracking actuator, to apply a first decelerating bias signal comprising a polarity opposite to the polarity of the first accelerating bias signal to the tracking actuator in order to decelerate the tracking actuator, and to close the tracking servo loop when the reproduction state shifts to the waiting state after the servo controller opens the tracking servo loop; and
the servo controller is configured to apply a second accelerating bias signal comprising a polarity opposite to the polarity of the first accelerating bias signal when the reproduction state shifts to the waiting state to the tracking actuator in order to return to the track followed in the reproduction state, to apply a second decelerating bias signal comprising a polarity opposite to the polarity of the first decelerating bias signal when the reproduction state shifts to the waiting state to the tracking actuator, and to close the tracking servo loop when the waiting state returns to the reproduction state after the servo controller opens the tracking servo loop.

5. An optical disc reproducing method comprising:
radiating a laser beam onto a recording surface of an optical disc comprising a land and a groove and receiving a reflection signal from the recording surface;
generating at least a tracking error signal from the reflection signal;
switching the polarity of the tracking error signal in a reproduction state where the optical disc is reproduced and in a waiting state where the reproduction is interrupted; and
executing at least a tracking servo controlling using the tracking error signal comprising a polarity switched and driving a tracking actuator provided with the optical pickup configured to receive the reflection signal.

6. The optical disc reproducing method of claim 5, wherein the polarity switching further comprises:
setting the polarity of the tracking error signal to a polarity by which the optical pickup is configured to follow a groove track in the reproduction state, and switching the polarity of the tracking error signal to a polarity by which the optical pickup is configured to follow a land track in the waiting state for an optical disc comprising recorded data only in the groove track; and
setting the polarity of the tracking error signal to a polarity by which the optical pickup is configured to follow the land track in the reproduction state and switching the polarity of the tracking error signal to a polarity by which the optical pickup is configured to follow the groove track in the waiting state for an optical disc comprising recorded data only in the land track.

7. The optical disc reproducing method of claim 5, wherein the driving comprises:
opening a tracking servo loop once before the polarity of the tracking error signal is switched, and
closing the tracking servo loop after the polarity of the tracking error signal is switched.

8. The optical disc reproducing method of claim 7, wherein the driving further comprises:
applying a first accelerating bias signal to the tracking actuator within a predetermined range from a current track in a predetermined direction in order to accelerate the tracking actuator, applying a first decelerating bias signal comprising a polarity opposite to the polarity of the first accelerating bias signal to the tracking actuator in order to decelerate the tracking actuator, and closing the tracking servo loop when the reproduction state shifts to the waiting state, after the tracking servo loop is opened; and
applying a second accelerating bias signal comprising a polarity opposite to the polarity of the first accelerating bias signal when the reproduction state shifts to the waiting state to the tracking actuator in order to return to the track followed in the reproduction state, applying a second decelerating bias signal comprising a polarity opposite to the polarity of the first decelerating bias signal when the reproduction state shifts to the waiting state to the tracking actuator, and closing the tracking servo loop when the waiting state returns to the reproduction state, after the tracking servo loop is opened.
